(19) United States
(12) Patent Application Publication
(10) Pub. No.: US 2024/0313950 A1
(43) Pub. Date: Sep. 19, 2024

(54) TERMINAL APPARATUS, MANAGEMENT APPARATUS, COMMUNICATION SYSTEM, COMMUNICATION METHOD, MANAGEMENT METHOD, AND NON-TRANSITORY COMPUTER READABLE MEDIUM

(71) Applicants: NEC Corporation, Minato-ku, Tokyo (JP); NEC Platforms, Ltd., Kawasaki-shi, Kanagawa (JP)

(72) Inventors: Ken TANAKA, Tokyo (JP); Ken-ichiro YOSHINO, Tokyo (JP); Tomoyasu IZUMIYA, Kanagawa (JP)

(73) Assignees: NEC Corporation, Minato-ku, Tokyo (JP); NEC Platforms, Ltd., Kawasaki-shi, Kanagawa (JP)

(21) Appl. No.: 18/569,656

(22) PCT Filed: Jun. 17, 2021
(86) PCT No.: PCT/JP2021/023078

§ 371 Date: Dec. 13, 2023

(51) Int. Cl. H04L 9/08

(52) U.S. Cl. CPC H04L 9/0819

(57) ABSTRACT

A terminal apparatus, a management apparatus, a communication system, a communication method, a management method, and a non-transitory computer readable medium capable of reliably acquiring a cryptographic key for quantum cryptographic communication are provided. A terminal apparatus (10) includes an acquisition unit (11) that acquires a cryptographic key from a management apparatus by designating communication source identification information and communication destination identification information for the management apparatus, and requesting the cryptographic key from the management apparatus, the management apparatus managing a cryptographic key distributed by using a QKD technology, and a communication unit (12) that performs cryptographic communication with another terminal apparatus by using the cryptographic key acquired by the acquisition unit (11).

### TECHNICAL FIELD

The present invention relates to a terminal apparatus, a management apparatus, a communication system, a communication method, a management method, and a non-transitory computer readable medium.

### BACKGROUND ART

In recent years, with the development of quantum computers, there has been an expectation that they will be applied in various fields. Meanwhile, cryptographic keys could be decrypted by such quantum computers, so that existing public key cypher systems could be compromised. Therefore, in order to achieve secure communication, there has been a demand for a quantum cryptographic technology by which the security of communication can be physically ensured rather than by computational complexity.

In quantum cryptography, a quantum key distribution (QKD: Quantum Key Distribution) technology which enables a cryptographic key to be securely shared between places remote from each other is used. For example, Patent Literature 1 discloses a technology related to the aforementioned technology. Patent Literature 1 discloses a technology in which the number of channels of QKD is increased by using a quantum-entanglement light source in a QKD system, thereby increasing the generating rate of cryptographic keys of the system as a whole.

### CITATION LIST

### Patent Literature

Patent Literature 1: Japanese Unexamined Patent Application Publication No. 2007-318445

### SUMMARY OF INVENTION

### Technical Problem

However, in the related technology, although cryptographic keys can be distributed to each of sites located in remote places by the QKD technology, it does not take into consideration how to designate, among a plurality of the distributed cryptographic keys, a key that is actually used for quantum cryptographic communication at every site. Therefore, in the related technology, it is difficult to acquire a cryptographic key common to all of the sites (hereinafter also referred to as a common cryptographic key) when quantum cryptographic communication is performed between sites.

An object of the present disclosure is to provide a terminal apparatus, a management apparatus, a communication system, a communication method, a management method, and a non-transitory computer readable medium capable of reliably acquiring a cryptographic key for quantum cryptographic communication.

### Solution to Problem

A terminal apparatus according to the present disclosure includes: acquisition means for acquiring a cryptographic key from a management apparatus by designating communication source identification information and communication destination identification information for the management apparatus, and requesting the cryptographic key from the management apparatus, the management apparatus managing a cryptographic key distributed by using a QKD (Quantum Key Distribution) technology; and communication means for performing cryptographic communication with another terminal apparatus by using the acquired cryptographic key.

A management apparatus according to the present disclosure includes: management means for managing a plurality of cryptographic keys distributed by using a QKD technology; and distribution means for distributing a cryptographic key to a terminal apparatus, the terminal apparatus being to perform cryptographic communication with another terminal apparatus, the cryptographic key being specified from among the plurality of managed cryptographic keys based on a request for the cryptographic key issued from the terminal apparatus, in which request, communication source identification information and communication destination identification information are designated.

A communication system according to the present disclosure is a communication system including a terminal apparatus and a management apparatus, in which the terminal apparatus includes: acquisition means for acquiring a cryptographic key from the management apparatus by designating communication source identification information and communication destination identification information for the management apparatus, and requesting the cryptographic key from the management apparatus; and communication means for performing cryptographic communication with another terminal apparatus by using the acquired cryptographic key, and the management apparatus includes: management means for managing a plurality of cryptographic keys distributed by using a QKD technology; and distribution means for distributing a cryptographic key to the terminal apparatus, the cryptographic key being specified from among the plurality of managed cryptographic keys based on a request for the cryptographic key issued from the terminal apparatus, in which request, communication source identification information and communication destination identification information are designated.

A communication method for a terminal apparatus according to the present disclosure includes: acquiring a cryptographic key from a management apparatus by designating communication source identification information and communication destination identification information for the management apparatus, and requesting the cryptographic key from the management apparatus, the management apparatus managing a cryptographic key distributed by using a QKD technology; and performing cryptographic communication with another terminal apparatus by using the acquired cryptographic key.

A management method for a management apparatus according to the present disclosure includes: managing a plurality of cryptographic keys distributed by using a QKD technology; and distributing a cryptographic key to a terminal apparatus, the terminal apparatus being to perform cryptographic communication with another terminal apparatus, the cryptographic key being specified from among the plurality of managed cryptographic keys based on a request for the cryptographic key issued from the terminal apparatus, in which request, communication source identification information and communication destination identification information are designated.

A non-transitory computer readable medium according to the present disclosure stores a program for causing a computer to perform processes including: acquiring a cryptographic key from a management apparatus by designating communication source identification information and communication destination identification information for the management apparatus, and requesting the cryptographic key from the management apparatus, the management apparatus managing a cryptographic key distributed by using a QKD technology; and performing cryptographic communication with another terminal apparatus by using the acquired cryptographic key.

A non-transitory computer readable medium according to the present disclosure stores a program for causing a computer to perform processes including: managing a plurality of cryptographic keys distributed by using a QKD technology; and distributing a cryptographic key to a terminal apparatus, the terminal apparatus being to perform cryptographic communication with another terminal apparatus, the cryptographic key being specified from among the plurality of managed cryptographic keys based on a request for the cryptographic key issued from the terminal apparatus, in which request, communication source identification information and communication destination identification information are designated.

### Advantageous Effects of Invention

According to the present disclosure, it is possible to provide a terminal apparatus, a management apparatus, a communication system, a communication method, a management method, and a non-transitory computer readable medium capable of reliably acquiring a cryptographic key for quantum cryptographic communication.

### BRIEF DESCRIPTION OF DRAWINGS

FIG. 1 is a configuration diagram showing an example of a configuration of a communication system according to related art;

FIG. 2 is a configuration diagram showing an outline of a terminal apparatus according to an example embodiment;

FIG. 3 is a configuration diagram showing an outline of a management apparatus according to an example embodiment;

FIG. 4 is a configuration diagram showing an example of a configuration of a communication system according to a first example embodiment;

FIG. 5 is a configuration diagram showing an example of a configuration of a management apparatus according to the first example embodiment;

FIG. 6 is a configuration diagram showing an example of a configuration of a terminal apparatus according to the first example embodiment;

FIG. 7 is a sequence diagram showing an example of operations performed by a communication system according to the first example embodiment;

FIG. 8 shows a specific example of a key management table according to the first example embodiment;

FIG. 9 shows a specific example of a key management table according to the first example embodiment;

FIG. 10 shows a specific example of a key management table according to the first example embodiment;

FIG. 11 shows a specific example of a key management table according to the first example embodiment;

FIG. 12 is a sequence diagram showing an example of operations performed by a communication system according to a second example embodiment;

FIG. 13 is a sequence diagram showing an example of operations performed by the communication system according to the second example embodiment;

FIG. 14 shows a specific example of a key management table according to the second example embodiment; and

FIG. 15 shows an example of a configuration of hardware of a computer according to an example embodiment.

### EXAMPLE EMBODIMENT

An example embodiment will be described hereinafter with reference to the drawings. The same reference numerals (or symbols) are assigned to the same components/structures throughout the drawings, and redundant descriptions thereof will be omitted as appropriate.

### Examination of Related Technology

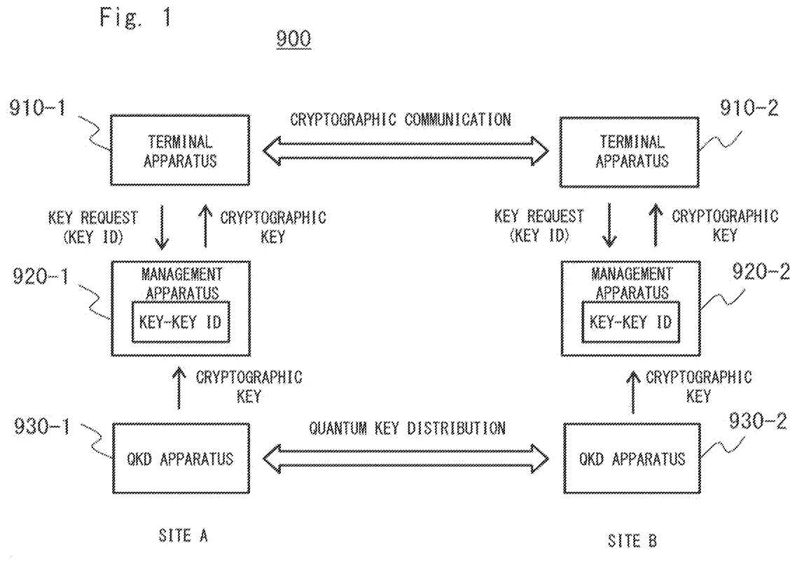

FIG. 1 shows an example of a configuration of a communication system according to related art. As shown in FIG. 1, a communication system 900 according to related art includes terminal apparatus 910-1 and 910-2, management apparatus 920-1 and 920-2, and QKD (Quantum Key Distribution) apparatuses 930-1 and 930-2. The management apparatus 920-1 and the QKD apparatus 930-1 are installed in a site A, and the terminal apparatus 910-1 performs cryptographic communication in the site A. The management apparatus 920-2 and the QKD apparatus 930-2 are installed in a site B, and the terminal apparatus 910-2 performs cryptographic communication in the site B.

The QKD apparatuses 930-1 and 930-2 generate (distribute) a common cryptographic key by performing a QKD between the QKD apparatuses in the respective sites. The management apparatuses 920-1 and 920-2 manage cryptographic keys generated by the QKD apparatuses 930-1 and 930-2 in the respective sites. The terminal apparatuses 910-1 and 910-2 acquire a cryptographic key managed by the management apparatuses 920-1 and 920-2 in the respective sites, and perform cryptographic communication between the terminal apparatuses by using the acquired cryptographic key.

The terminal apparatuses 910-1 and 910-2 have to use the same cryptographic key to perform quantum cryptographic communication. Since the management apparatuses 920-1 and 920-2 have accumulated a plurality of cryptographic keys generated by the QKD apparatuses 930-1 and 930-2, the terminal apparatuses 910-1 and 910-2 need to designate the same cryptographic key and acquire it from the management apparatuses 920-1 and 920-2 when they perform quantum cryptographic communication.

As a related technology, it is conceivable to adopt a method in which a cryptographic key is designated by a key ID which is one unique ID in order to designate the same cryptographic key. That is, the management apparatus 920-1 manages a cryptographic key by associating a key ID with the cryptographic key, and the management apparatus 920-2 also manages a cryptographic key by associating a key ID with the cryptographic key in a similar manner. In this case, the terminal apparatuses 910-1 and 910-2 acquire a cryptographic key from the management apparatuses 920-1 and 920-2, respectively, by designating the same key ID and thereby requesting the same cryptographic key. In this way, the terminal apparatuses 910-1 and 910-2 can use the same cryptographic key.

However, the inventors of the present application have studied such a related technology and, as a result of the study, found the following problem. That is, when terminal apparatuses acquire a cryptographic key by designating its key ID, the terminal apparatuses have to share the key ID to be used (i.e., have to have the same Key ID) in advance. Therefore, it is necessary to perform a method for checking information about the key ID to be requested between the terminal apparatuses. Then, as a prerequisite, it is necessary that the terminal apparatuses be online, and if the terminal apparatuses are not connected to each other online, they cannot acquire the same cryptographic key. Further, it is also conceivable to share a predetermined key ID between terminal apparatuses in advance. In this case, the terminal apparatuses can acquire the same cryptographic key by using the key ID which has been shared between them in advance. However, the number of keys that can be requested is limited to the number corresponding to the number of key IDs that have shared in advance, so that it is impossible to acquire the number of cryptographic keys larger than the number of key IDs that have shared in advance.

### Outline of Example Embodiment

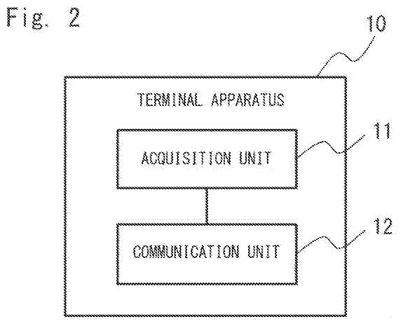

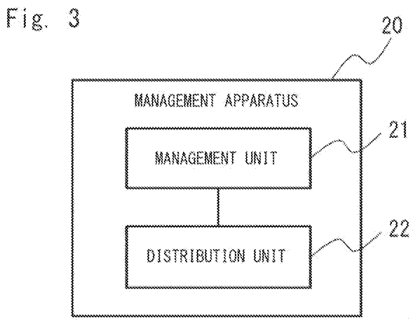

FIG. 2 shows an outline of a terminal apparatus according to an example embodiment, and FIG. 3 shows an outline of a management apparatus according to an example embodiment. Similarly to FIG. 1, the terminal apparatus 10 and the management apparatus 20 according to the example embodiment constitute a communication system.

As shown in FIG. 2, the terminal apparatus 10 includes an acquisition unit 11 and a communication unit 12. The acquisition unit 11 acquires a cryptographic key from the management apparatus 20 by designating communication source identification information and communication destination identification information for the management apparatus 20, which manages cryptographic keys distributed by using a QKD (Quantum Key Distribution) technology (hereinafter also referred to as “QK-distributed”), thereby requesting the cryptographic key. The communication unit 12 performs cryptographic communication with another terminal apparatus by using the cryptographic key acquired by the acquisition unit 11. For example, the communication source identification information and the communication destination identification information (key designation information) designated by the terminal apparatus 10 include identification information of either or both of the management apparatus 20 and the terminal apparatus 10.

As shown in FIG. 3, the management apparatus 20 includes a management unit 21 and a distribution unit 22. The management unit 21 manages a plurality of QK-distributed cryptographic keys. The distribution unit 22 distributes, to the terminal apparatus 10 that performs cryptographic communication with another terminal apparatus, a cryptographic key that is specified from among the plurality of cryptographic keys managed by the management unit 21 based on a request for the cryptographic key in which communication source identification information and communication destination identification information issued from the terminal apparatus 10 are designated.

By the above-described configuration, when terminal apparatuses perform quantum cryptographic communication therebetween, they can reliably acquire a common cryptographic key by designating communication source identification information and communication destination identification information. Therefore, it is possible to acquire a cryptographic key without sharing a key ID or the like between terminal apparatuses in advance.

### First Example Embodiment

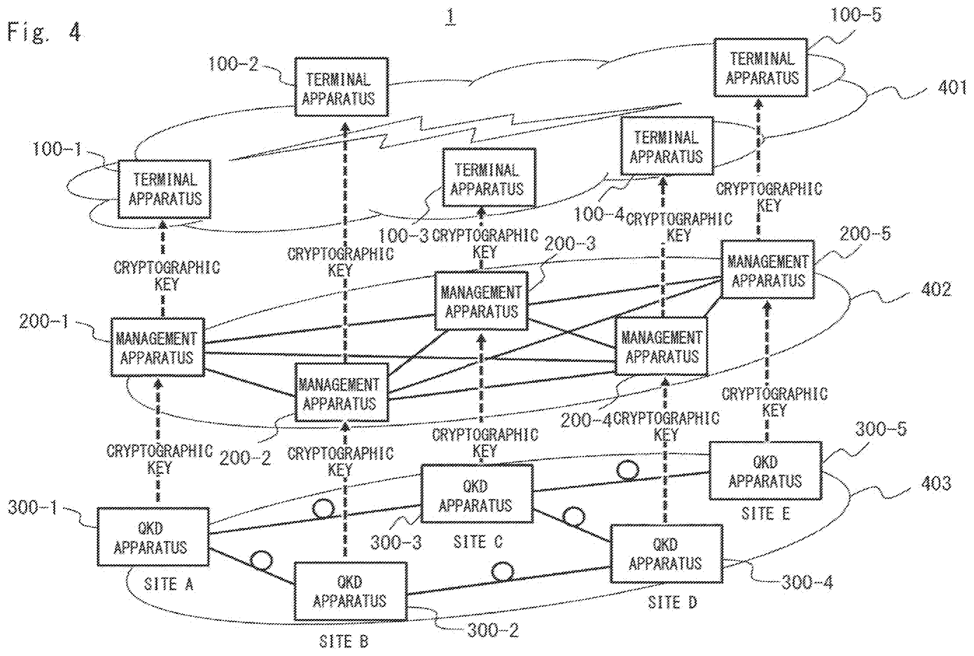

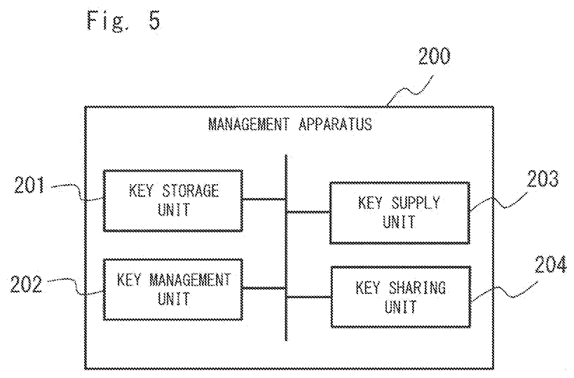

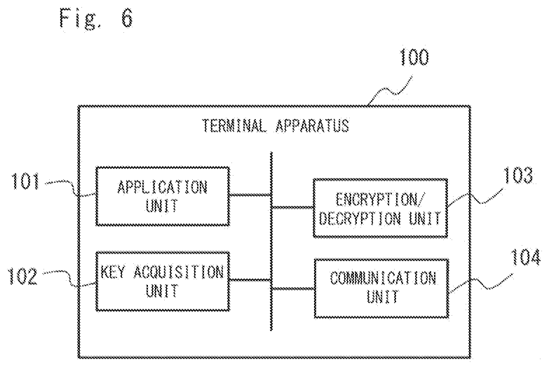

Next, a first example embodiment will be described. FIG. 4 shows an example of a configuration of a communication system according to this example embodiment, and FIG. 5 shows an example of a configuration of a management apparatus according to this example embodiment. Further, FIG. 6 shows an example of a configuration of a terminal apparatus according to this example embodiment.

As shown in FIG. 4, a communication system 1 according to this example embodiment includes a plurality of terminal apparatuses 100, a plurality of management apparatuses 200, and a plurality of QKD apparatuses 300. In this example, a QKD apparatus 300 is installed in each site, and a management apparatus 200 corresponding to each QKD apparatus 300 is also instead in each site. Further, a terminal apparatus 100 is accommodated in each management apparatus 200. For example, QKD apparatuses 300-1 to 300-5 and the management apparatuses 200-1 to 200-5 are installed in sites A to E, respectively, and terminal apparatuses 100-1 to 100-5 performs cryptographic communication in the site A to E, respectively.

Each of the QKD apparatus 300 generates (distributes) a cryptographic key in its respective site by using a QKD technology. The QKD apparatuses 300-1 to 300-5 constitutes a quantum key generation layer (network) 403 that generates a quantum key. The QKD apparatus 300 is connected to another QKD apparatus 300 in one-to-one manner through an optical fiber, and performs a QKD with the QKD apparatus connected thereto. For example, a pair of QKD apparatuses 300 perform, within a 50 km range, optical fiber transmission therebetween.

The QKD apparatus 300 generates, for example, a photon train in a polarized state based on a randomly selected basis corresponding to a bit string of random numbers, and transmits the generated photon train to the other QKD apparatus 300 through an optical fiber. The other QKD apparatus 300 observes the received photon train based on the randomly selected basis and notifies the QKD apparatus 300 (i.e., the QKD apparatus that has transmitted the photon train) of the result of the observation. The bits of the photon train of which the basis matches each other between the QKD apparatus 300 and the other QKD apparatus 300 becomes a cryptographic key (shared key). In this way, it is possible to reliably detect wire-tapping or the like performed by a third party, and the wire-tapped bits are discarded. Therefore, only a secure cryptographic key which have not been wire-tapped can be shared (generated).

The management apparatus 200 manages cryptographic keys generated by the QKD apparatus 300 in the respective site. The management apparatuses 200-1 to 200-5 constitute a key management layer (network) 402 in which cryptographic keys are managed. The quantum key generation layer 403 and the key management layer 402 also serve as a QKD platform for providing securer cryptographic keys by using a QKD technology.

The management apparatus 200 accumulates cryptographic keys that the QKD apparatus 300 has generated by using the QKD technology, and manages the consumption (supply) of accumulated cryptographic keys. The management apparatus 200 distributes a cryptographic key in response to a request from the terminal apparatus 100 through a key supply interface for supplying a cryptographic key. The key supply interface is adapted to the terminal apparatus 100 (application) and is a secure interface. The key supply interface may be any wired or wireless communication path as long as its security is ensured. For example, the key supply interface may be an interface for USB (Universal Serial Bus), LAN (Local Area Network), or near-field radio communication using a contactless IC card such as FeliCa (Registered Trademark). The management apparatuses 200 are mesh-connected to each other by arbitrary communication paths and may share management information of cryptographic keys therebetween. The communication path between the management apparatuses 200 may be any communication path as long as the management information of cryptographic keys can be shared therebetween.

As shown in FIG. 5, the management apparatus 200 includes a key storage unit 201, a key management unit 202, a key supply unit 203, and a key sharing unit 204. The configuration shown in FIG. 5 is merely an example, and any other configuration may be used as long as the operations in this example embodiment can be performed. For example, the key storage unit 201 and the key management unit 202 may be formed as a management unit that stores and manages cryptographic keys.

The key storage unit 201 stores and accumulates cryptographic keys generated by the QKD apparatus 300. The key storage unit 201 accumulates bits that are QK-distributed by the QKD apparatus 300 in order of generation, and stores them in such a manner that a predetermined number of generated bits (e.g., 128 Kbytes) is regarded (or handled) as one cryptographic key. The key storage unit 201 stores a key management table (key management information) for managing cryptographic keys. The key management table is generated and stored in each pair of sites between which cryptographic keys are shared, so that the same cryptographic keys are managed (i.e., stored) in a pair of the cryptographic keys. For example, the management apparatus 200-1 located in the site A shares cryptographic keys with the management apparatus 200-2 located in the site B, and also shares cryptographic keys with the management apparatus 200-3 located in the site C. Therefore, the management apparatus 200-1 located in the site A stores a key management table for the sites A and B and a key management table for the sites A and C. In the key management table, key IDs are associated with cryptographic keys for managing the cryptographic keys, and a communication source ID and a communication destination ID are associated with the cryptographic keys. Further, a distribution history(ies) for the terminal apparatuses 100 at the communication source and the communication destination is associated with the cryptographic keys.

The key ID is unique key identification information for uniquely identifying a cryptographic key. When a cryptographic key is generated, the management apparatus 200 assigns a key ID according to a predetermined rule, and the same key ID is assigned to the same cryptographic key in each of a pair of management apparatuses 200. The communication source ID and communication destination ID are communication source identification information and communication destination identification information for identifying the communication source (transmission source) and communication destination (transmission destination) for performing cryptographic communication between the applications of the pair of terminal apparatuses 100, and also serve as information for designating (specifying) a cryptographic key to be distributed (requested). In this example, the communication source identification information and communication destination identification information are identification information of either the terminal apparatuses 100 at the communication source and communication destination or the management apparatuses 200 in which the terminal apparatuses 100 are accommodated at the communication source and communication destination. The distribution history is information for identifying (or indicating) whether or not a cryptographic key has already been distributed or has not yet been distributed to the terminal apparatuses 100 at the communication source and communication destination.

The key management unit 202 manages a plurality of cryptographic keys stored in the key storage unit 201. The key management unit 202 assigns a key ID to a cryptographic key generated by the QKD apparatus 300, and stores (i.e., records) the assigned key ID and the cryptographic key in association with each other in a key management table. The key management unit 202 manages cryptographic keys to be distributed by using the key management table, and specifies a cryptographic key to be distributed to the terminal apparatus 100 based on the designated communication source ID and communication destination ID in response to a key request issued from the terminal apparatus 100. The key management unit 202 specifies, in the key management table, a cryptographic key to be distributed according to whether or not there is a cryptographic key corresponding to the communication source ID and communication destination ID designated by the key request issued from the terminal apparatus 100. For example, when there is no cryptographic key corresponding to the communication source ID and communication destination ID designated by the key request in the key management table, the key management unit 202 associates the communication source ID and communication destination ID with a cryptographic key selected from a plurality of accumulated cryptographic keys and thereby specifies the cryptographic key to be distributed to the terminal apparatuses 100. Further, when there is a cryptographic key corresponding to the communication source ID and communication destination ID designated by the key request in the key management table, the key management unit 202 specifies that cryptographic key as a cryptographic key to be distributed to the terminal apparatuses 100. Further, the key management unit 202 updates the distribution history of the key management table according to the distribution of the cryptographic key.

The key supply unit 203 distributes a cryptographic key stored in the key storage unit 201 to the terminal apparatus 100. The key supply unit 203 receives a key request from the terminal apparatus 100 through a key supply interface and distributes a cryptographic key specified according to the received key request by the key management unit 202 to the terminal apparatus 100. Note that the key supply unit 203 preferably distributes the cryptographic key only to terminal apparatuses 100 in which the distribution of a cryptographic key is permitted. For example, the management apparatus 200 stores a permission list (identification information list) of terminal apparatuses to which a cryptographic key can be distributed, and distributes a cryptographic key to terminal apparatuses 100 registered in the permission list.

The key sharing unit 204 shares key distribution information with the other management apparatus 200. The other management apparatus 200, which shares the key, is the management apparatus 200 that accommodates the terminal apparatus 100 with which the terminal apparatus 100, which has requested the key, communicates. The key sharing unit 204 also serves as a notification unit that, when the key management table is updated, reports the updating of the key management table. The key management table is updated when a cryptographic key is distributed to the terminal apparatus 100, so it can be said that the key sharing unit 204 reports the updating of the key management table when a cryptographic key is distributed. The key sharing unit 204 transmits key distribution information included (or recorded) in the key management table when the key management table is updated. The key distribution information is information for specifying the cryptographic key distributed to the terminal apparatus 100. The key distribution information is preferably information by which the distributed cryptographic key can be specified without including the cryptographic key itself. For example, the key sharing unit 204 notifies the other management apparatus 200 of the key ID of the distributed cryptographic key, the communication source ID, and the communication destination ID as key distribution information. Further, when the key sharing unit 204 receives key distribution information from the other management apparatus 200, it updates the key management table according to the key ID, the communication source ID, and the communication destination ID included in the received key distribution information. For example, the communication source ID and communication destination ID are associated with the cryptographic key corresponding to the received key ID, and the distribution history is thereby updated.

The terminal apparatus 100 performs cryptographic communication by using the cryptographic key supplied from the management apparatus 200 in the respective site. The terminal apparatuses 100-1 to 100-5 constitute an application layer (network) 401 for performing cryptographic communication. The terminal apparatuses 100 can be connected to each other directly or indirectly through any communication path, and they perform secure communication by the supplied cryptographic key. The terminal apparatus 100 may be a mobile communication apparatus such as a smartphone or a notebook PC (Personal Computer), or a non-mobile communication apparatus such as a fixed desktop PC or a server. The terminal apparatus 100 may move to another site, acquire a cryptographic key from a management apparatus 200 located at that site, and perform cryptographic communication. The communication path between the terminal apparatuses 100 may be any communication path as long as cryptographic communication can be performed by using the cryptographic key.

As shown in FIG. 6, the terminal apparatus 100 includes an application unit 101, a key acquisition unit 102, an encryption/decryption unit 103, and a communication unit 104. The configuration shown in FIG. 6 is merely an example, and any other configuration may be used as long as the operations in this example embodiment can be performed. For example, the encryption/decryption unit 103 and the communication unit 104 may be formed as a cryptographic communication unit that performs cryptographic communication by using a cryptographic key.

The application unit 101 executes an application for performing cryptographic communication between terminal apparatuses. Identification information (ID of each terminal apparatus 100 or each management apparatus 200), which will be a communication source ID or a communication destination ID, is set in advance in the application unit 101. The application unit 101 determines a communication source ID and a communication destination ID according to the transmission source and transmission destination of data selected by an operation performed by a user. The application unit 101 also serves as a determination unit that determines a communication source ID and a communication destination ID when data is transmitted. In this example, identification information of either the terminal apparatus 100 or the management apparatus 200 at the transmission source and transmission destination is used as the communication source ID and communication destination ID. Further, the application unit 101 generates plaintext data to be transmitted to the other terminal apparatus 100 in response to an input or the like from a user, and outputs plaintext data that has been received from the other terminal apparatus 100 and decrypted for the user.

The key acquisition unit 102 requests and acquires a cryptographic key from the management apparatus 200 when it performs cryptographic communication with the other terminal apparatus 100 (terminal apparatus on the other side). The key acquisition unit 102 acquires a cryptographic key from the management apparatus 200 by designating the communication source ID and communication destination ID that is determined by the application unit 101 when data is transmitted or determined by the communication unit 104 when data is received, and thereby requesting the cryptographic key. The key acquisition unit 102 transmits a key request including the communication source ID and communication destination ID to the management apparatus 200 through a key supply interface, and acquires the cryptographic key from the management apparatus 200 to which the key acquisition unit 102 has issued the request. The key acquisition unit 102 requests a cryptographic key according to the length of communication data to be transmitted or received. For example, the request for the cryptographic key may be repeated based on the length of the communication data and the length of the cryptographic key, or the length of the necessary cryptographic key may be designated in the request for the cryptographic key.

The encryption/decryption unit 103 performs an encryption process or a decryption process by using the cryptographic key acquired by the key acquisition unit 102. The encryption/decryption unit 103 encrypts plaintext data to be transmitted and decrypts received cypher data. The encryption/decryption unit 103 performs encryption/decryption by Vernam cipher such as a one time pad (OTP). That is, the encryption/decryption unit 103 encrypts/decrypts 1-bit data by using a 1-bit cryptographic key and discards the used cryptographic key after the use.

The communication unit 104 performs cryptographic communication with the other terminal apparatus 100. The communication unit 104 transmits cypher data encrypted by the encryption/decryption unit 103 to the terminal apparatus 100 located at the communication destination. Further, the communication unit 104 receives cypher data from the terminal apparatus 100 located at the communication source, and specifies a communication source ID and a communication destination ID from the received cypher data.

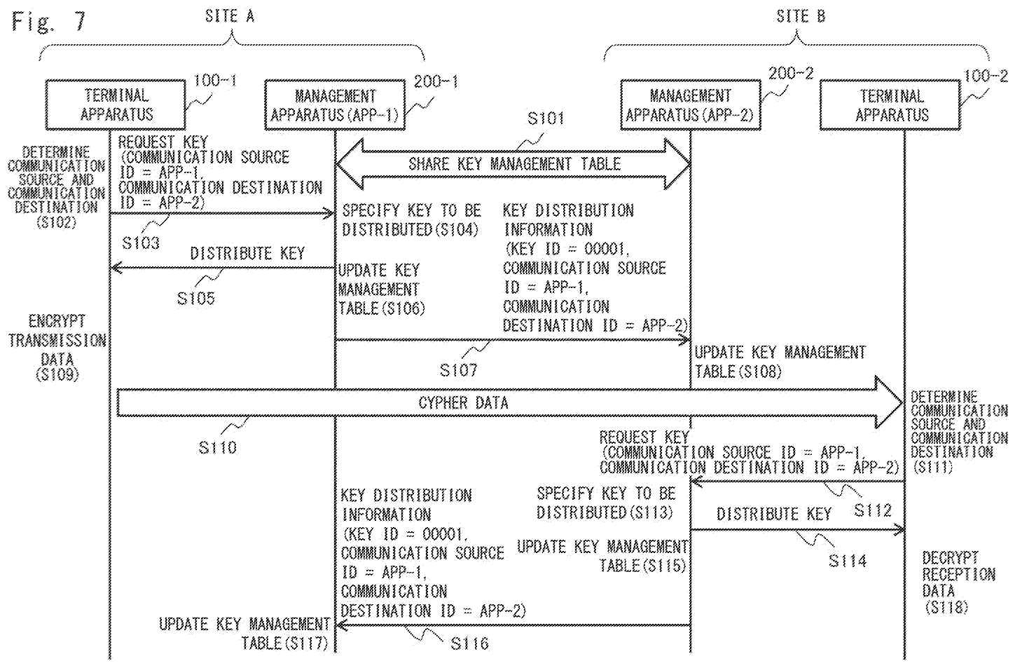

FIG. 7 shows an example of operations performed by the communication system according to this example embodiment. This example of operations includes a communication method performed in the terminal apparatus 100 and a management method performed in the management apparatus 200. In this example embodiment, the management apparatus 200 at the respective site accommodates one terminal apparatus 100, and identification information for identifying a communication source or a communication destination is set in either the management apparatus 200 or the terminal apparatus 100. In this example, APP-1 is set as identification information in the management apparatus 200-1 in the site A, and APP-2 is set as identification information in the management apparatus 200-2 in the site B. An example in which data is transmitted from the terminal apparatus 100-1 located in the site A to the terminal apparatus 100-2 located in the site B will be described with reference to FIG. 7.

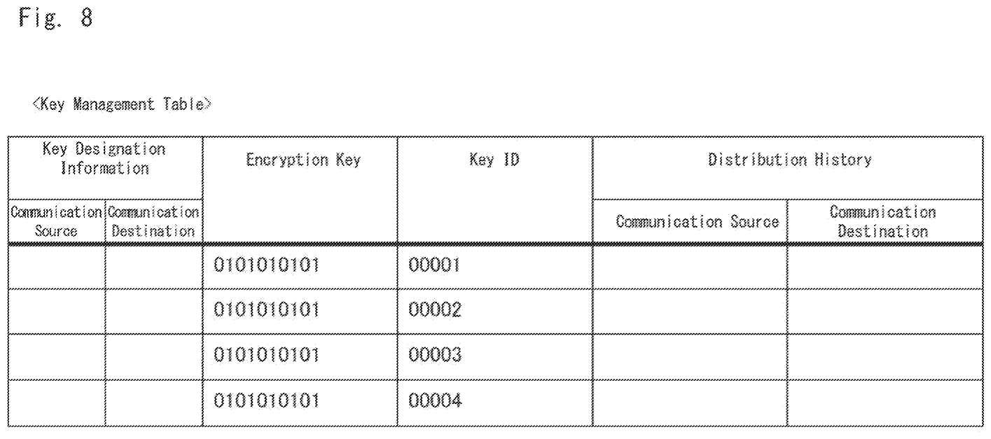

Firstly, the management apparatuses 200-1 and 200-2 share a key management table including cryptographic keys generated by the QKD apparatuses 300-1 and 300-2 (S101). FIG. 8 shows a specific example of the key management table shared by them in this state. For example, as shown in FIG. 8, cryptographic keys each of which has a predetermined bit length, generated by the QKD apparatus 300 are accumulated (i.e., recorded) in the key management table, and key IDs each of which is associated with a respective cryptographic key are stored (i.e., recorded). The key storage units 201 of the management apparatuses 200-1 and 200-2 store the cryptographic keys each of which has the same predetermined bit length, and each of the key management units 202 of the management apparatuses 200-1 and 200-2 assigns a key ID to each of the cryptographic keys by the same method. For example, a value that is obtained by successively incrementing the same initial value is assigned, as a key ID, to each of the cryptographic keys in order of generation of the cryptographic keys. In this way, the same cryptographic keys having the same key IDs are stored in the key storage units 201 of the management apparatuses 200-1 and 200-2, so that the key management table is shared therebetween.

Next, the terminal apparatus 100-1 on the transmission side determines a communication source and a communication destination when it transmits data (S102). In the terminal apparatus 100-1, in order to transmit data, a user operates an application for cryptographic communication and selects a terminal apparatus at the communication destination (on the receiving side). For example, the application unit 101 of the terminal apparatus 100-1 sets the ID on the other terminal apparatus side at the communication destination (i.e., the ID of the management apparatus 200-2) that has been selected according to the operation performed by the user as Communication Destination ID=APP-2, and sets the ID on the own terminal apparatus side at the communication source (i.e., the ID of the management apparatus 200-1) as Communication Source ID=APP-1.

Next, the terminal apparatus 100-1 transmits a key request including the communication source and the communication destination to the management apparatus 200-1 (S103). The key acquisition unit 102 of the terminal apparatus 100-1 transmits a key request including Communication Source ID=APP-1 and Communication Destination ID=APP-2 determined by the application unit 101 to the management apparatus 200-1 through a key supply interface. For example, since one cryptographic key is acquired by one key request, the key acquisition unit 102 repeatedly transmits the key request according to the length of data to be encrypted/decrypted and the length of the cryptographic key.

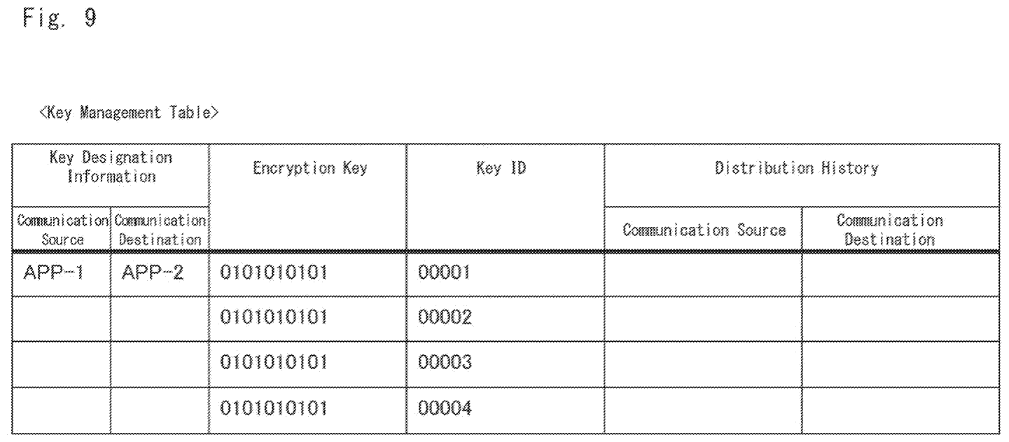

Next, when the management apparatus 200-1 receives the key request from the terminal apparatus 100-1, it specifies the cryptographic key to be distributed based on the communication source and the communication destination included in the received key request (S104). The key management unit 202 of the management apparatus 200-1 refers to the key management table and retrieves a cryptographic key corresponding to Communication Source ID=APP-1 and Communication Destination ID=APP-2 designated in the key request. For example, in the case of the key management table shown in FIG. 8, there is no cryptographic key which corresponds to Communication Source ID=APP-1 and Communication Destination ID=APP-2. Therefore, the key management unit 202 assigns the first cryptographic key (e.g., a cryptographic key having the smallest key ID) among the unassigned cryptographic keys in the key management table for Communication Source ID=APP-1 and Communication Destination ID=APP-2, and uses the assigned cryptographic key as the cryptographic key to be distributed. Specifically, as shown in FIG. 9, the key management unit 202 assigns a cryptographic key having key ID=00001 for Communication Source ID=APP-1 and Communication Destination ID=APP-2, and thereby associates the communication source ID and communication destination ID, to which the cryptographic key is assigned, with the cryptographic key and stores them in the key management table.

Note that when there is a cryptographic key corresponding to Communication Source ID=APP-1 and Communication Destination ID=APP-2 in the key management table, the key management unit 202 assigns the first cryptographic key among the unassigned cryptographic keys, except for the corresponding cryptographic key (i.e., the one that has already been distributed to the communication source), for Communication Source ID=APP-1 and Communication Destination ID=APP-2 in order to distribute the cryptographic key to the communication source.

Next, the management apparatus 200-1 distributes the specified cryptographic key to the terminal apparatus 100-1 (S105). The key supply unit 203 of the management apparatus 200-1 transmits the cryptographic key having key ID=00001 for Communication Source ID=APP-1 and Communication Destination ID=APP-2 assigned by the key management unit 202 to the terminal apparatus 100-1 through the key supply interface.

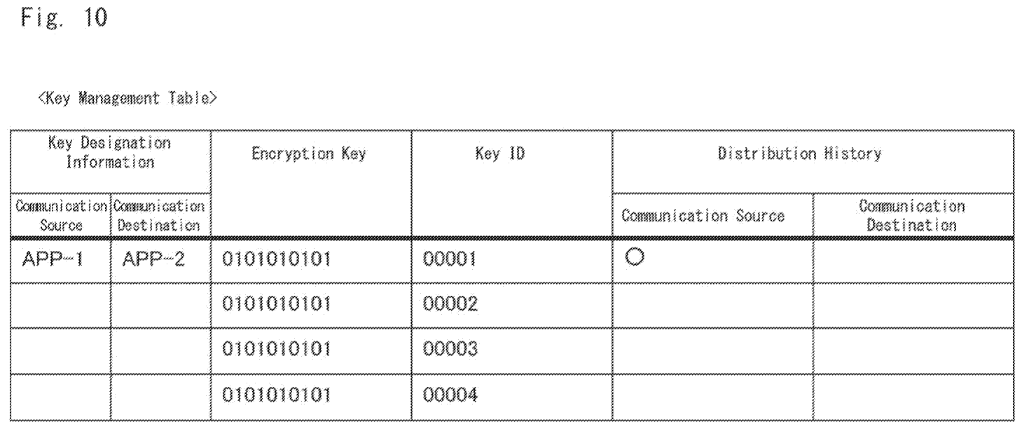

Next, when the management apparatus 200-1 distributes the cryptographic key to the terminal apparatus 100-1, it updates the key management table (S106). The key management unit 202 of the management apparatus 200-1 updates the distribution history of the key management table according to the distribution of the cryptographic key. Specifically, as shown in FIG. 10, since the cryptographic key having key ID=00001 for Communication Source ID=APP-1 and Communication Destination ID=APP-2 has already been distributed to the terminal apparatus 100-1 located at the communication source, the communication source in the distribution history is set as “Already Distributed” (circle in the example shown in FIG. 10).

Next, the management apparatus 200-1 notifies the management apparatus 200-2 of key distribution information (S107). When the key management table is updated (when the cryptographic key is distributed), the key sharing unit 204 of the management apparatus 200-1 transmits the key distribution information to the management apparatus 200-2 through the communication path between the management apparatuses in order to share the updated information therebetween. The key sharing unit 204 transmits the key distribution information corresponding to the cryptographic key distributed to the terminal apparatus 100-1 located at the communication source to the management apparatus 200-2. In this example, the key distribution information includes Key ID=00001, Communication Source ID=APP-1, and Communication Destination ID=APP-2. The key sharing unit 204 specifies the management apparatus 200-2 that accommodates the terminal apparatus 100-2 located at the communication destination based on the communication destination ID (APP-2), and transmits the key distribution information to the specified management apparatus 200-2. For example, when there are a plurality of communication paths, the key distribution information is transmitted through the communication path corresponding to the specified management apparatus 200-2.

Next, when the management apparatus 200-2 receives the key distribution information from the management apparatus 200-1, it updates the key management table according to the received key distribution information (S108). The key management unit 202 of the management apparatus 200-2 refers to the key management table and updates the information about the cryptographic key corresponding to Key ID=00001 included in the received key distribution information. For example, when the cryptographic key corresponding to Key ID=00001 is searched for in the state of the key management table shown in FIG. 8, no communication source ID, no communication destination ID, and no distribution history are set for the corresponding cryptographic key. Therefore, Communication Source ID=APP-1 and Communication Destination ID=APP-2 included in the received key distribution information are associated with the cryptographic key corresponding to Key ID=00001. Further, since the key distribution information has been received from the management apparatus 200-1 on the transmitting side (at the communication source), “Already Distributed” is set at the communication source in the distribution history. FIG. 10 shows the updated key management table, and the key management table is shared by the management apparatuses 200-1 and 200-2.

On the other hand, when the cryptographic key is distributed from the management apparatus 200-1, the terminal apparatus 100-1 on the transmission side encrypts transmission data (S109). The encryption/decryption unit 103 of the terminal apparatus 100-1 encrypts the transmission data (plaintext data) by Vernam cipher by using the acquired cryptographic key. When the length of the transmission data is equal to or shorter than the length of the cryptographic key, the transmission data is encrypted by using one cryptographic key, whereas when the length of the transmission data exceeds the length of the cryptographic key, the transmission data is encrypted by using a plurality of cryptographic keys. For example, when the length of the cryptographic key is 128 Kbytes and the length of the transmission data is 100 Kbytes, the transmission data is encrypted by using the first 100 Kbytes of the acquired cryptographic key. Further, when the length of the cryptographic key is 128 Kbytes and the length of the transmission data is 200 Kbytes, two cryptographic keys are acquired. Then, the transmission data is encrypted by using 128 Kbytes of the first cryptographic key and first 72 Kbytes of the second cryptographic key. Note that the same applies to the decryption.

Next, the terminal apparatus 100-1 transmits the encrypted cypher data to the terminal apparatus 100-2 on the receiving side (S110). In order to perform cryptographic communication, the communication unit 104 of the terminal apparatus 100-1 transmits the cypher data to the terminal apparatus 100-2 through the communication path between the terminal apparatuses. The communication unit 104 transmits, to the terminal apparatus 100-2, the cypher data together with Communication Source ID=APP-1 and Communication Destination ID=APP-2 included therein (e.g., included in the header of the cypher data). The communication unit 104 specifies the terminal apparatus 100-2 at the communication destination based on the communication destination ID (APP-2) and transmits the cypher data to the specified terminal apparatus 100-2. For example, when there are a plurality of communication paths, the cypher data is transmitted through the communication path corresponding to the specified terminal apparatus 100-2.

Next, when the terminal apparatus 100-2 on the receiving side receives the cypher data from the terminal apparatus 100-1, it determines the communication source and the communication destination (S111). The communication unit 104 of the terminal apparatus 100-2 acquires the communication source ID and communication destination ID from the received cypher data (e.g., from the header of the cypher data), and determines as Communication Source ID=APP-1 and Communication Destination ID=APP-2.

Next, the terminal apparatus 100-2 transmits a key request including the communication source and the communication destination to the management apparatus 200-2 (S112). Similarly to the terminal apparatus 100-1 on the transmission side, the key acquisition unit 102 of the terminal apparatus 100-2 transmits the key request including Communication Source ID=APP-1 and Communication Destination ID=APP-2 determined by the communication unit 104 to the management apparatus 200-2 through the key supply interface.

Next, when the management apparatus 200-2 receives the key request from the terminal apparatus 100-2, it specifies a key to be distributed based on the communication source and the communication destination included in the received key request (S113). Similarly to the management apparatus 200-1 on the transmission side, the key management unit 202 of the management apparatus 200-2 refers to the key management table and searches for a cryptographic key corresponding to Communication Source ID=APP-1 and Communication Destination ID=APP-2 designated in the key request. For example, in the case of the key management table shown in FIG. 10, there is a cryptographic key which corresponds to Communication Source ID=APP-1 and Communication Destination ID=APP-2 (which has already been distributed to the communication source, but has not yet been distributed to the communication destination). Therefore, the key management unit 202 determines the cryptographic key which corresponds to Communication Source ID=APP-1 and Communication Destination ID=APP-2, has not yet been distributed to the communication destination, and has Key ID=00001 as the cryptographic key to be distributed to the communication destination. Note that when there are two or more cryptographic keys which correspond to Communication Source ID=APP-1 and Communication Destination ID=APP-2, the key management unit 202 determines the first cryptographic key (e.g., a cryptographic key having the smallest key ID) which has not yet been distributed to the communication destination as the cryptographic key to be distributed. Further, when there is no cryptographic key which corresponds to Communication Source ID=APP-1 and Communication Destination ID=APP-2, the key management unit 202 assigns, similarly to the assignment on the transmission side (S104), the first cryptographic key among the unassigned cryptographic keys in the key management table as the one for the distribution.

Next, the management apparatus 200-2 distributes the specified cryptographic key to the terminal apparatus 100-2 (S114). The key supply unit 203 of the management apparatus 200-2 transmits the cryptographic key having Key ID=00001 for Communication Source ID=APP-1 and Communication Destination ID=APP-2 specified by the key management unit 202 to the terminal apparatus 100-2 through the key supply interface.

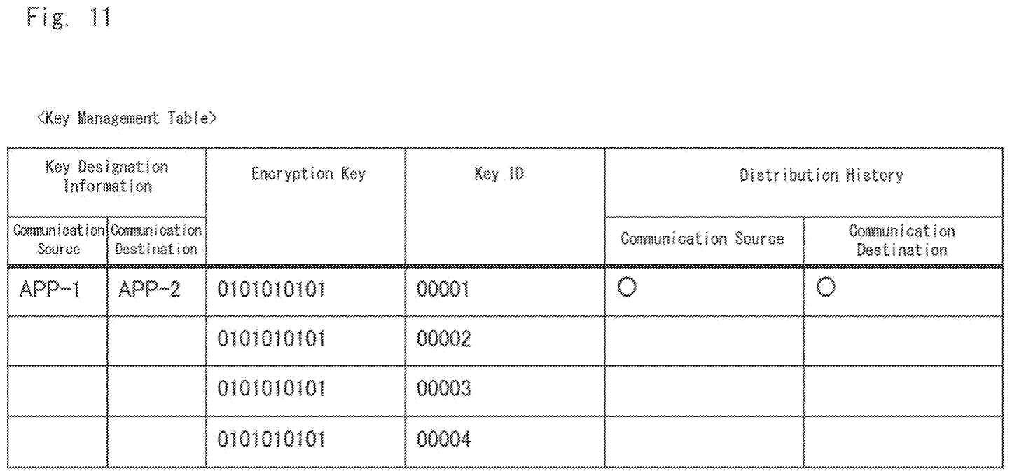

Next, when the management apparatus 200-2 distributes the cryptographic key to the terminal apparatus 100-2, it updates the key management table (S115). Similarly to the management apparatus 200-1 on the transmission side, the key management unit 202 of the management apparatus 200-2 updates the distribution history of the key management table according to the distribution of the cryptographic key. Specifically, as shown in FIG. 11, since the cryptographic key having Key ID=00001 for Communication Source ID=APP-1 and Communication Destination ID=APP-2 has already been distributed to the terminal apparatus 100-2 located at the communication destination, the communication destination in the distribution history is set as “Already Distributed”.

Next, the management apparatus 200-2 notifies the management apparatus 200-1 of the key distribution information (S116). When the key management table is updated, similarly to the management apparatus 200-1 on the transmission side, the key sharing unit 204 of the management apparatus 200-2 transmits key distribution information to the management apparatus 200-1 through the communication path between the management apparatuses in order to share the updated information therebetween. The key sharing unit 204 transmits the key distribution information including Key ID=00001, Communication Source ID=APP-1, and Communication Destination ID=APP-2 corresponding to the cryptographic key already distributed to the terminal apparatus 100-2 located at the communication destination to the management apparatus 200-1. The key sharing unit 204 specifies the management apparatus 200-1 located at the communication source based on the communication source ID (APP-1) and transmits the key distribution information to the specified management apparatus 200-1.

Next, when the management apparatus 200-1 receives the key distribution information from the management apparatus 200-2, it updates the key management table according to the received key distribution information (S117). Similarly to the management apparatus 200-2 on the receiving side, the key management unit 202 of the management apparatus 200-1 refers to the key management table and updates the information about the cryptographic key corresponding to Key ID=00001 included in the received key distribution information. For example, when the cryptographic key corresponding to Key ID=00001 is searched for in the state of the key management table shown in FIG. 10, Communication Source ID=APP-1 and Communication Destination ID=APP-2 are associated with the corresponding cryptographic key, and the communication source is “Already Distributed” and the communication destination is “Not Distributed” in the distribution history. Regarding the cryptographic key corresponding to Key ID=00001, Communication Source ID=APP-1, and Communication Destination ID=APP-2, since the key distribution information has been received from the management apparatus 200-2 on the receiving side (at the communication destination), the communication destination in the distribution history is set as “Already Distributed”. FIG. 11 shows the updated key management table, and the key management table is shared by the management apparatuses 200-1 and 200-2.

On the other hand, when the cryptographic key is distributed from the management apparatus 200-2, the terminal apparatus 100-2 on the receiving side decrypts the received data (cypher data) received from the terminal apparatus 100-1 (S118). The encryption/decryption unit 103 of the terminal apparatus 100-2 decrypts the received cypher data to plaintext data by Vernam cipher by using the acquired the cryptographic key.

As described above, in this example embodiment, the terminal apparatus acquires a cryptographic key from the management apparatus by, instead of designating a key ID, designating a key based on a communication source ID and a communication destination ID which are set in advance. In this way, there is no need to acquire a key by using a key ID, which is necessary in related art, so that there is no need to share the key ID in advance. Therefore, by performing necessary setting only once on the terminal apparatus side, it is possible to acquire a cryptographic key irrespective of whether the terminal apparatus is online or not, and without limiting the amount of the key to be acquired.

### Second Example Embodiment

Next, a second example embodiment will be described. In this example embodiment, an example in which identification information is set in each of the management apparatus and the terminal apparatus in the communication system according to the first example embodiment will be described. The configuration of the communication system and that of each apparatus are similar to those in the first example embodiment, and therefore descriptions thereof are omitted.

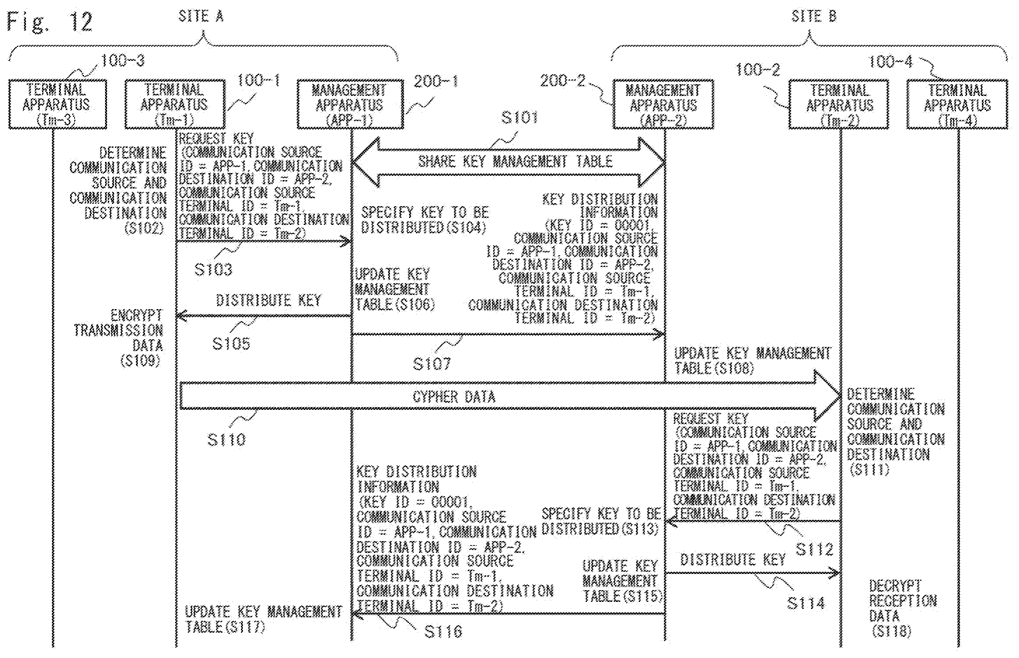

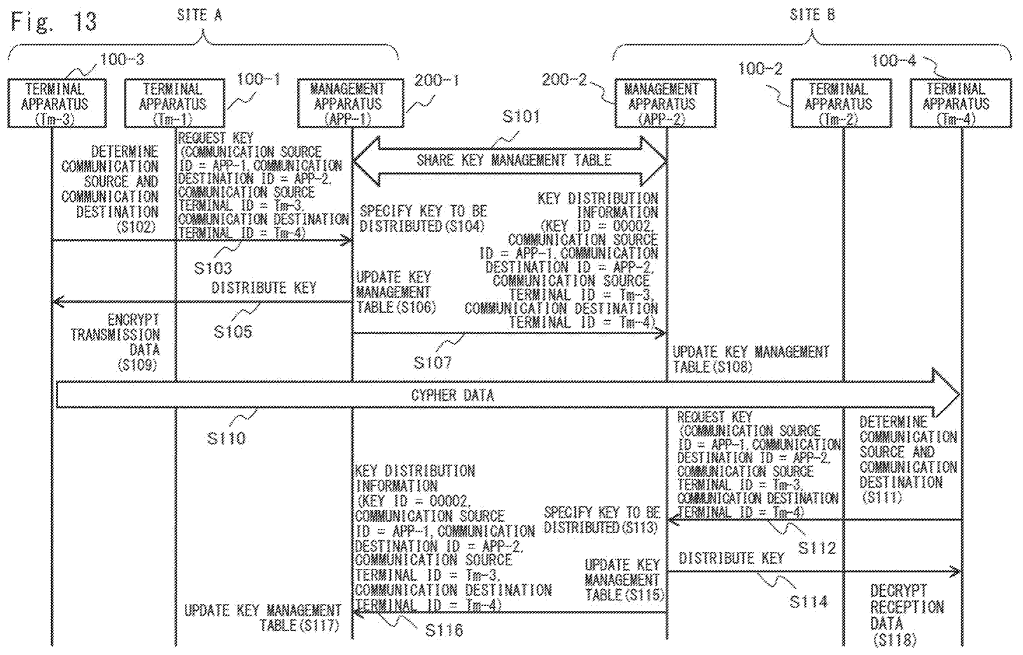

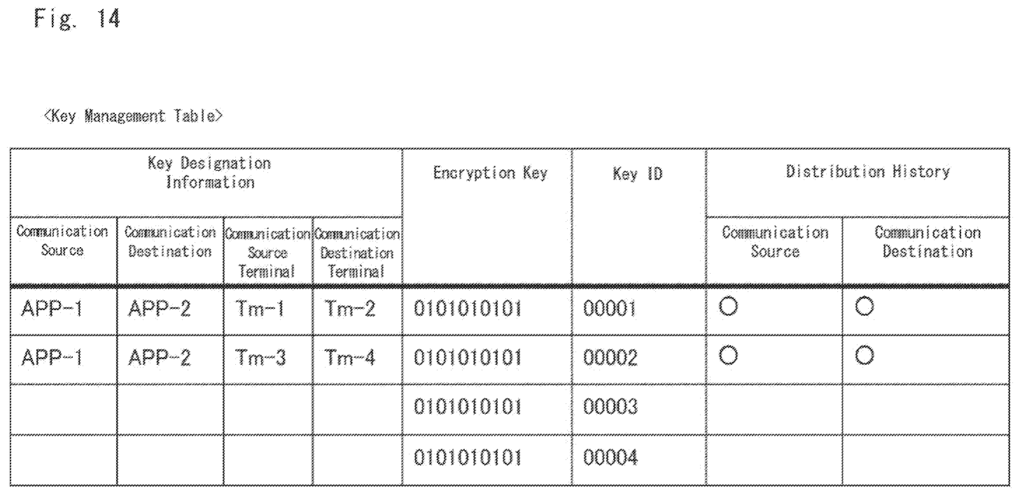

FIGS. 12 and 13 show an example of operations performed by a communication system according to this example embodiment, and FIG. 14 shows a specific example of a key management table according to this example embodiment. In this example embodiment, a management apparatus 200 at each site accommodates two terminal apparatuses 100, and identification information for identifying a communication source or a communication destination is set in the management apparatus 200 and the terminal apparatuses 100. In this example, in a site A, APP-1 is set in a management apparatus 200-1; Tm-1 is set in a terminal apparatus 100-1; and Tm-3 is set in a terminal apparatus 100-3. Further, in a site B, APP-2 is set in a management apparatus 200-2; Tm-2 is set in a terminal apparatus 100-2; and Tm-4 is set in a terminal apparatus 100-4. As shown in FIG. 14, in the key management table according to this example embodiment, a communication source ID (communication source management unit ID), a communication destination ID (communication destination management apparatus ID), a communication source terminal ID, and a communication destination terminal ID are associated with a cryptographic key. That is, communication source identification information and communication destination identification information associated with a cryptographic key in the key management table include identification information of terminal apparatuses 100 and management apparatuses 200 located at the communication source and the communication destination.

As shown in FIG. 12, when data is transmitted from the terminal apparatus 100-1 located in the site A to the terminal apparatus 100-2 located in the site B, similarly to the first example embodiment, in the state in which the management apparatuses 200-1 and 200-2 share the key management table (S101), the terminal apparatus 100-1 determines a communication source and a communication destination when it transmits data (S102) and transmits a key request to the management apparatus 200-1 (S103). In this process, the terminal apparatus 100-1 transmits a key request including Communication Source ID=APP-1, Communication Destination ID=APP-2, Communication Source Terminal ID=Tm-1, and Communication Destination Terminal ID=Tm-2, determined according to an operation performed by a user to the management apparatus 200-1. In this example, similarly to the key management table, the communication source identification information and communication destination identification information designated in the key request include identification information of the terminal apparatus 100 and identification information of the management apparatus 200 in the communication source and the communication destination.

Next, the management apparatus 200-1 specifies a cryptographic key to be distributed based on the communication source ID, the communication destination ID, the communication source terminal ID, and the communication destination terminal ID included in the received key request (S104), and distributes the specified the cryptographic key to the terminal apparatus 100-1 (S105). In this process, the management apparatus 200-1 specifies the cryptographic key to be distributed by referring to the key management table and thereby searching for a cryptographic key corresponding to Communication Source ID=APP-1, Communication Destination ID=APP-2, Communication Source Terminal ID=Tm-1, and Communication Destination Terminal ID=Tm-2 designated in the key request. For example, the management apparatus 200-1 transmits a cryptographic key having Key ID=00001 assigned for Communication Source ID=APP-1, Communication Destination ID=APP-2, Communication Source Terminal ID=Tm-1, and Communication Destination Terminal ID=Tm-2 to the terminal apparatus 100-1.

Next, the management apparatus 200-1 updates the key management table (S106) and notifies the management apparatus 200-2 of the key distribution information (S107). The management apparatus 200-2 updates the key management table according to the received key distribution information (S108). In this example, the key distribution information includes Key ID=00001 of the cryptographic key distributed to the terminal apparatus 100-1, Communication Source ID=APP-1, Communication Destination ID=APP-2, Communication Source Terminal ID=Tm-1, and Communication Destination Terminal ID=Tm-2.

Further, the terminal apparatus 100-1 on the transmission side encrypts transmission data by using the distributed cryptographic key (S109), and transmits the encrypted cypher data to the terminal apparatus 100-2 on the reception side (S110). In this process, the terminal apparatus 100-1 transmits the cypher data together with Communication Source ID=APP-1, Communication Destination ID=APP-2, Communication Source Terminal ID=Tm-1, and Communication Destination Terminal ID=Tm-2 included therein to the terminal apparatus 100-2.

Next, the terminal apparatus 100-2 on the receiving side determines the communication source and the communication destination based on the received cypher data (S111), and transmits a key request including the determined communication source and the communication destination to the management apparatus 200-2 (S112). In this process, the terminal apparatus 100-2 transmits the key request including Communication Source ID=APP-1, Communication Destination ID=APP-2, Communication Source Terminal ID=Tm-1, and Communication Destination Terminal ID=Tm-2 acquired from the received cypher data to the management apparatus 200-2.

After that, similarly to the first example embodiment and to the transmission side, the management apparatus 200-2 distributes the cryptographic key to the terminal apparatus 100-2 (S113, S114), updates the key management table, and reports the key distribution information (S115-S117). In this example, the key distribution information includes Key ID=00001 of the cryptographic key distributed to the terminal apparatus 100-2, Communication Source ID=APP-1, Communication Destination ID=APP-2, Communication Source Terminal ID=Tm-1, and Communication Destination Terminal ID=Tm-2. Further, the terminal apparatus 100-2 decrypts the received cypher data by using the distributed cryptographic key (S118).

Further, as shown in FIG. 13, when data is transmitted from the terminal apparatus 100-3 located in the site A to the terminal apparatus 100-4 located in the site B, the terminal apparatus 100-3 on the transmission side transmits a key request including Communication Source ID=APP-1, Communication Destination ID=APP-2, Communication Source Terminal ID=Tm-3, and Communication Destination Terminal ID=Tm-4 to the management apparatus 200-1 (S103). For example, the management apparatus 200-1 notifies the management apparatus 200-2 of key distribution information including Key ID=00002 of the cryptographic key distributed to the terminal apparatus 100-3, Communication Source ID=APP-1, Communication Destination ID=APP-2, Communication Source Terminal ID=Tm-3, and Communication Destination Terminal ID=Tm-4 (S107). The terminal apparatus 100-4 on the receiving side transmits a key request including Communication Source ID=APP-1, Communication Destination ID=APP-2, Communication Source Terminal ID=Tm-3, and Communication Destination Terminal ID=Tm-4 to the management apparatus 200-2 (S112). For example, the management apparatus 200-2 notifies the management apparatus 200-1 of key distribution information including Key ID=00002 of the cryptographic key distributed to the terminal apparatus 100-4, Communication Source ID=APP-1, Communication Destination ID=APP-2, Communication Source Terminal ID=Tm-3, and Communication Destination Terminal ID=Tm-4 (S116).

As described above, in this example embodiment, a cryptographic key is acquired by setting identification information in the management apparatus and the terminal apparatus, and designating a communication source and a communication destination while including the aforementioned identification information therein from the terminal apparatus. In this way, even in the case where a plurality of terminal apparatuses are accommodated in a management apparatus in each site, a cryptographic key can be designated for each terminal apparatus, so that the cryptographic key can be reliably distributed to each terminal apparatus.

Note that the present disclosure is not limited to the above-described example embodiments and various modifications can be made thereto within the scope and spirit of the disclosure.

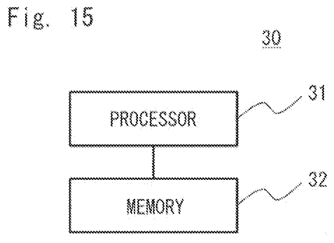

Each of the components/structures in the above-described example embodiments may be formed by software, hardware, or both of them. Further, each of the apparatuses may be formed by one hardware device or one software program, or a plurality of hardware devices or a plurality of software programs. Each apparatus and each function (process) may be implemented by a computer 30 including a processor 31 such as a CPU (Central Processing Unit), and a memory 32, which is a storage device, as shown in FIG. 15. For example, a program for performing a method (a communication method or a management method) in an example embodiment may be stored in the memory 32, and each function may be implemented by having the processor 31 execute the program stored in the memory 32.

Such programs include a set of instructions (or software codes) that, when being loaded into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disk (DVD), a Blu-ray (registered trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

Although the present disclosure has been described with reference to example embodiments, the present disclosure is not limited to the above-described example embodiments. Various modifications that can be understood by those skilled in the art can be made to the configuration and details of the present disclosure within the scope of the disclosure.

The whole or part of the example embodiments disclosed above can be described as, but not limited to, the following Supplementary notes.

### Supplementary Note 1

A terminal apparatus comprising:
acquisition means for acquiring a cryptographic key from a management apparatus by designating communication source identification information and communication destination identification information for the management apparatus, and requesting the cryptographic key from the management apparatus, the management apparatus managing a cryptographic key distributed by using a QKD (Quantum Key Distribution) technology; and
communication means for performing cryptographic communication with another terminal apparatus by using the acquired cryptographic key.

### Supplementary Note 2

The terminal apparatus described in Supplementary note 1, wherein the communication source identification information and the communication destination identification information include identification information of either or both of the management apparatus and the terminal apparatus.

### Supplementary Note 3

The terminal apparatus described in Supplementary note 1 or 2, wherein the acquisition means requests the cryptographic key according to a length of communication data.

### Supplementary Note 4

The terminal apparatus described in Supplementary note 3, wherein the acquisition means repeats the request for the cryptographic key based on a length of communication data and a length of the cryptographic key.

### Supplementary Note 5

The terminal apparatus described in any one of Supplementary notes 1 to 4, wherein the communication means performs encryption or decryption by Vernam cipher.

### Supplementary Note 6

The terminal apparatus described in any one of Supplementary notes 1 to 5, further comprising determination means for determining, when transmitting data, the communication source identification information and the communication destination identification information according to a transmission source and a transmission destination of the data, wherein
the communication means transmits data encrypted by the acquired cryptographic key to the other terminal apparatus.

### Supplementary Note 7

The terminal apparatus described in any one of Supplementary notes 1 to 6, wherein the communication means determines, when receiving data, the communication source identification information and the communication destination identification information based on the received data, and decrypts the received data by the acquired the cryptographic key.

### Supplementary Note 8

A management apparatus comprising:
management means for managing a plurality of cryptographic keys distributed by using a QKD technology; and
distribution means for distributing a cryptographic key to a terminal apparatus, the terminal apparatus being to perform cryptographic communication with another terminal apparatus, the cryptographic key being specified from among the plurality of managed cryptographic keys based on a request for the cryptographic key issued from the terminal apparatus, in which request, communication source identification information and communication destination identification information are designated.

### Supplementary Note 9

The management apparatus described in Supplementary note 8, wherein the communication source identification information and the communication destination identification information include identification information of either or both of the management apparatus and the terminal apparatus.

### Supplementary Note 10

The management apparatus described in Supplementary note 8 or 9, wherein the management means manages the cryptographic key management information in which the cryptographic key is associated with the communication source identification information and the communication destination identification information.

### Supplementary Note 11

The management apparatus described in Supplementary note 10, wherein when there is, in the cryptographic key management information, no cryptographic key corresponding to the communication source identification information and the communication destination identification information designated in the request, the management means specifies a cryptographic key to be distributed to the terminal apparatus by associating the communication source identification information and the communication destination identification information with a cryptographic key selected from the plurality of cryptographic keys.

### Supplementary Note 12

The management apparatus described in Supplementary note 10 or 11, wherein when there is, in the cryptographic key management information, a cryptographic key corresponding to the communication source identification information and the communication destination identification information designated in the request, the management means specifies the corresponding cryptographic key as a cryptographic key to be distributed to the terminal apparatus.

### Supplementary Note 13

The management apparatus described in any one of Supplementary notes 10 to 12, further comprising sharing means for sharing the cryptographic key management information with another management apparatus accommodating another terminal apparatus.

### Supplementary Note 14

The management apparatus described in Supplementary note 13, wherein when the cryptographic key management information is updated, the sharing means notifies the other management apparatus of the updating of the cryptographic key management information.

### Supplementary Note 15

The management apparatus described in Supplementary note 14, wherein
in the cryptographic key management information, the cryptographic key is associated with cryptographic key identification information, and
the sharing means transmits, as the notification, the cryptographic key identification information corresponding to the distributed cryptographic key in the cryptographic key management information, the communication source identification information, and the communication destination identification information to the other management apparatus.

### Supplementary Note 16

The management apparatus described in Supplementary note 15, wherein when the sharing means receives the notification, the sharing means updates the cryptographic key management information according to the cryptographic key identification information, the communication source identification information, and the communication destination identification information.

### Supplementary Note 17

The management apparatus described in any one of Supplementary notes 10 to 16, wherein in the cryptographic key management information, the cryptographic key is associated with a history of distribution of a communication source and a communication destination to the terminal apparatus.

### Supplementary Note 18

A communication system comprising a terminal apparatus and a management apparatus, wherein
the terminal apparatus comprises:
acquisition means for acquiring a cryptographic key from the management apparatus by designating communication source identification information and communication destination identification information for the management apparatus, and requesting the cryptographic key from the management apparatus; and
communication means for performing cryptographic communication with another terminal apparatus by using the acquired cryptographic key, and
the management apparatus comprises:
management means for managing a plurality of cryptographic keys distributed by using a QKD technology; and
distribution means for distributing a cryptographic key to the terminal apparatus, the cryptographic key being specified from among the plurality of managed cryptographic keys based on a request for the cryptographic key issued from the terminal apparatus, in which request, communication source identification information and communication destination identification information are designated.

### Supplementary Note 19

A communication method for a terminal apparatus, comprising:
acquiring a cryptographic key from a management apparatus by designating communication source identification information and communication destination identification information for the management apparatus, and requesting the cryptographic key from the management apparatus, the management apparatus managing a cryptographic key distributed by using a QKD technology; and
performing cryptographic communication with another terminal apparatus by using the acquired cryptographic key.

### Supplementary Note 20

A management method for a management apparatus, comprising:
managing a plurality of cryptographic keys distributed by using a QKD technology; and
distributing a cryptographic key to a terminal apparatus, the terminal apparatus being to perform cryptographic communication with another terminal apparatus, the cryptographic key being specified from among the plurality of managed cryptographic keys based on a request for the cryptographic key issued from the terminal apparatus, in which request, communication source identification information and communication destination identification information are designated.

### Supplementary Note 21

A non-transitory computer readable medium storing a program for causing a computer to perform processes including:
acquiring a cryptographic key from a management apparatus by designating communication source identification information and communication destination identification information for the management apparatus, and requesting the cryptographic key from the management apparatus, the management apparatus managing a cryptographic key distributed by using a QKD technology; and
performing cryptographic communication with another terminal apparatus by using the acquired cryptographic key.

### Supplementary Note 22

A non-transitory computer readable medium storing a program for causing a computer to perform processes including:
managing a plurality of cryptographic keys distributed by using a QKD technology; and
distributing a cryptographic key to a terminal apparatus, the terminal apparatus being to perform cryptographic communication with another terminal apparatus, the cryptographic key being specified from among the plurality of managed cryptographic keys based on a request for the cryptographic key issued from the terminal apparatus, in which request, communication source identification information and communication destination identification information are designated.

### REFERENCE SIGNS LIST

1 COMMUNICATION SYSTEM
10 TERMINAL APPARATUS
11 ACQUISITION UNIT
12 COMMUNICATION UNIT
20 MANAGEMENT APPARATUS
21 MANAGEMENT UNIT
22 DISTRIBUTION UNIT
30 COMPUTER
31 PROCESSOR
32 MEMORY
100 TERMINAL APPARATUS
101 APPLICATION UNIT
102 KEY ACQUISITION UNIT
103 ENCRYPTION/DECRYPTION UNIT
104 COMMUNICATION UNIT
200 MANAGEMENT APPARATUS
201 KEY STORAGE UNIT
202 KEY MANAGEMENT UNIT
203 KEY SUPPLY UNIT
204 KEY SHARING UNIT
300 QKD APPARATUS
401 APPLICATION LAYER
402 KEY MANAGEMENT LAYER
403 QUANTUM KEY GENERATION LAYER

What is claimed is:

1. A terminal apparatus comprising:
at least one memory storing instructions, and
at least one processor configured to execute the instructions stored in the at least one memory to;
acquire a cryptographic key from a management apparatus by designating communication source identification information and communication destination identification information for the management apparatus, and requesting the cryptographic key from the management apparatus, the management apparatus managing a cryptographic key distributed by using a QKD (Quantum Key Distribution) technology; and
perform cryptographic communication with another terminal apparatus by using the acquired cryptographic key.

2. The terminal apparatus according to claim 1, wherein the communication source identification information and the communication destination identification information include identification information of either or both of the management apparatus and the terminal apparatus.

3. The terminal apparatus according to claim 1, wherein the at least one processor is further configured to execute the instructions stored in the at least one memory to request the cryptographic key according to a length of communication data.

4. The terminal apparatus according to claim 3, wherein the at least one processor is further configured to execute the instructions stored in the at least one memory to repeat the request for the cryptographic key based on the a length of the communication data and a length of the cryptographic key.

5. The terminal apparatus according to claim 1, wherein the at least one processor is further configured to execute the instructions stored in the at least one memory to perform encryption or decryption by Vernam cipher.

6. The terminal apparatus according to claim 1, wherein the at least one processor is further configured to execute the instructions stored in the at least one memory to determine, when transmitting data, the communication source identification information and the communication destination identification information according to a transmission source and a transmission destination of the data, and
transmit data encrypted by the acquired cryptographic key to the other terminal apparatus.

7. The terminal apparatus according to claim 1, wherein the at least one processor is further configured to execute the instructions stored in the at least one memory to determine, when receiving data, the communication source identification information and the communication destination identification information based on the received data, and decrypt the received data by the acquired the cryptographic key.

8. A management apparatus comprising:
at least one memory storing instructions, and
at least one processor configured to execute the instructions stored in the at least one memory to;
manage a plurality of cryptographic keys distributed by using a QKD technology; and
distribute a cryptographic key to a terminal apparatus, the terminal apparatus being to perform cryptographic communication with another terminal apparatus, the cryptographic key being specified from among the plurality of managed cryptographic keys based on a request for the cryptographic key issued from the terminal apparatus, in which request, communication source identification information and communication destination identification information are designated.

9. The management apparatus according to claim 8, wherein the communication source identification information and the communication destination identification information include identification information of either or both of the management apparatus and the terminal apparatus.

10. The management apparatus according to claim 8, wherein the at least one processor is further configured to execute the instructions stored in the at least one memory to manage the cryptographic key management information in which the cryptographic key is associated with the communication source identification information and the communication destination identification information.

11. The management apparatus according to claim 10, wherein the at least one processor is further configured to execute the instructions stored in the at least one memory to, when there is, in the cryptographic key management information, no cryptographic key corresponding to the communication source identification information and the communication destination identification information designated in the request, specify a cryptographic key to be distributed to the terminal apparatus by associating the communication source identification information and the communication destination identification information with a cryptographic key selected from the plurality of cryptographic keys.

12. The management apparatus according to claim 10, wherein the at least one processor is further configured to execute the instructions stored in the at least one memory to, when there is, in the cryptographic key management information, a cryptographic key corresponding to the communication source identification information and the communication destination identification information designated in the request, specify the corresponding cryptographic key as a cryptographic key to be distributed to the terminal apparatus.

13. The management apparatus according to claim 10, wherein the at least one processor is further configured to execute the instructions stored in the at least one memory to share the cryptographic key management information with another management apparatus accommodating another terminal apparatus.

14. The management apparatus according to claim 13, wherein the at least one processor is further configured to execute the instructions stored in the at least one memory to, when the cryptographic key management information is updated, notify the other management apparatus of the updating of the cryptographic key management information.

15. The management apparatus according to claim 14, wherein
in the cryptographic key management information, the cryptographic key is associated with cryptographic key identification information, and
the at least one processor is further configured to execute the instructions stored in the at least one memory to transmit, as the notification, the cryptographic key identification information corresponding to the distributed cryptographic key in the cryptographic key management information, the communication source identification information, and the communication destination identification information to the other management apparatus.

16. The management apparatus according to claim 15, wherein the at least one processor is further configured to execute the instructions stored in the at least one memory to, when the sharing means receives the notification, update the cryptographic key management information according to the cryptographic key identification information, the communication source identification information, and the communication destination identification information.

17. The management apparatus according to claim 10, wherein in the cryptographic key management information, the cryptographic key is associated with a history of distribution of a communication source and a communication destination to the terminal apparatus.

18. A communication system comprising the terminal apparatus according to claim 1 and a management apparatus, wherein
the management apparatus comprises:
management means for managing a plurality of cryptographic keys distributed by using a QKD technology; and
distribution means for distributing a cryptographic key to the terminal apparatus, the cryptographic key being specified from among the plurality of managed cryptographic keys based on a request for the cryptographic key issued from the terminal apparatus, in which request, communication source identification information and communication destination identification information are designated.

19. (canceled)

20. A management method for a management apparatus, comprising:
managing a plurality of cryptographic keys distributed by using a QKD technology; and
distributing a cryptographic key to a terminal apparatus, the terminal apparatus being to perform cryptographic communication with another terminal apparatus, the cryptographic key being specified from among the plurality of managed cryptographic keys based on a request for the cryptographic key issued from the terminal apparatus, in which request, communication source identification information and communication destination identification information are designated.

21-22. (canceled)
